(19) United States
(12) Patent Application Publication
(10) Pub. No.: US 2010/0026797 A1
(43) Pub. Date: Feb. 4, 2010

(54) DISPLAY DEVICE

(75) Inventors: Patrick Peter Elizabeth Meuwissen, Eindhoven (NL); Abraham Karel Riemens, Eersel (NL); Siebe TJerke De Zwart, Valkenswaard (NL); Ingrid Emilieene Joanna Rita Heynderickx, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/521,030

(22) PCT Filed: Dec. 19, 2007
(86) PCT No.: PCT/IB2007/055230

§ 371 Date: Jun. 24, 2009

Related U.S. Application Data
(60) Provisional application No. 60/883,195, filed on Jan. 3, 2007.

(51) Int. Cl. H04N 13/04; G06T 15/00

(52) U.S. Cl. 348/59; 348/51; 345/419; 348/E13.075

(57) ABSTRACT

A display device (2) for displaying a scene (104) comprising a shared image component (102) and a private image component (106), wherein the display device is adapted to display a plurality of perspectives of the shared image component and a plurality of views of each of the plurality of perspectives such that a multi-view perspective (P₁; P₂) of the shared image component is visible at each of a plurality of viewing zones, the display device being further adapted to display the private image component such that it is visible at one or more, but not all of the viewing positions.

This invention relates to a display device, and particularly but not exclusively to a multi-view auto-stereoscopic display device.

The generation of three-dimensional images generally requires that a display device is capable of providing a different view to the left and the right eye of a user of the display device. This can be achieved by providing a separate image directly to each eye of the user by use of specially constructed goggles. In one example, a display provides alternating left and right views in a time sequential manner, which views are admitted to a corresponding eye of the viewer by synchronised viewing goggles.

The term ‘stereoscopic viewing’ used herein refers to the capability of a viewer to perceive depth by proper interpretation of the differences between the two images perceived by the two eyes of the viewer.

An auto-stereoscopic display device generates a three-dimensional image without the need to use special eyewear such as goggles.

It is advantageous to provide a multi-perspective, multi-view auto-stereoscopic display device.

It is also advantageous to provide a 3-D game board comprising a multi-view auto-stereoscopic display device in which a display panel forming the display device is orientated substantially horizontally in use.

Accordingly there is provided a display device for displaying a scene comprising a shared image component and a private image component, wherein the display device is adapted to display a plurality of perspectives of the shared image component and a plurality of views of each of the plurality of perspectives such that a multi-view perspective of the shared image component is visible at each of a plurality of viewing zones, the display device being further adapted to display the private image component such that it is visible at one or more, but not all of the viewing positions.

Users of the display device positioned at different viewing zones may each see a different perspective of a scene displayed by the display device. In addition each user may also see private information that is not visible to the other users of the display device.

The term “scene” (or “3-D scene”) refers to the overall content displayed by a display. Typically the scene comprises a data set in a computer describing object positions in 3-D space. Objects, shapes, textures and other features are also defined by the data set.

The display device may comprise:
a display panel for displaying the scene;
a first layer in optical association with the display panel adapted to generate: a plurality of perspectives of the shared image component; and
the private image;
a second layer in optical association with the display panel adapted to generate a plurality of views of each perspective of the shared image component.

Accordingly there is further provided a display device comprising:
a display panel for displaying a scene, perspectives of which are visible at a plurality of viewing zones;
a first layer in optical association with the display panel adapted to generate a plurality of perspectives of the scene;
a second layer in optical association with the display panel adapted to generate a plurality of views of a respective perspective such that a multi-view perspective of the scene is visible at each viewing zone.

The image may comprise a shared image component, a perspective of which is visible at each viewing zone, and a private image component visible at least one, but not all viewing zones, the first layer being adapted to generate: a plurality of perspectives of the shared image content; and the private image component.

The term viewpoint as used herein defines the position in space from which a viewer views the display device, and the term ‘viewing angle’ defines the angle at which the display panel is viewed from a particular viewpoint. Where an image may be visible within a range of viewing angles, that range is defined as a ‘viewing zone’.

When displaying perspectives of an image to different viewing zones, a different perspective will be visible at each viewing zone. It is thus desirable that the different perspectives are well separated from one another in order that a perspective viewable at a first viewing zone is not corrupted by cross talk from a perspective displayed a second viewing zone.

On the other hand, the plurality of views of each perspective will be visible to a user positioned in a particular viewing zone. As explained hereinabove, each of the plurality of views should have a relatively narrow field. In addition, graceful fade over between adjacent views is desirable. This means that some crosstalk between adjacent views is acceptable.

By using two separate layers, each layer in optical association with a display panel, the first layer for generating different perspectives of an image, and the second layer for generating a plurality of relatively closely spaced views of each perspective, these differing requirements can be separately met whilst maintaining the quality of the resulting image.

The image content may comprise a plurality of private image components each visible at one or more, but not all of the viewing zones.

This means that, for example, when the display device is used as a game board, certain types of information may be visible to one player but not to other players. Alternatively, information may be visible to some but not all of the players.

Each private image component may be visible within a single viewing zone only, or from a single viewing angle only.

It may be desirable for the private image component to be three dimensional. In such a situation, the second layer is adapted to generate a plurality of views of the or a respective private image component visible at the or each viewing position respectively.

The shared image component may comprise an image, although it may also comprise data.

The or each private component may comprise data, although it could also comprise an image.

The display panel may have an in use substantially horizontal orientation. Such an orientation is particularly convenient for use when the display device is to be used as a game board.

The display panel may comprise a plurality of separately addressable pixels arranged in rows and columns. Preferably, each pixel comprises three sub-pixels. Each sub-pixel is adapted in use to generate red, green or blue light such that each pixel comprises one each of a red, green or blue sub-pixel. Advantageously, each pixel comprises an LCD cell.

The first layer comprises a barrier layer comprising a plurality of slits, each of which slits extends in a direction that is substantially parallel to the rows of pixels.

Alternatively, the first layer comprises a lenticular screen or colour filters.

The second layer may comprise a lenticular screen comprising a plurality of elongate lenticular elements.

Each row of pixels forming the display panel may comprise a plurality of groups of pixels, each pixel in a group providing a different view of the image, wherein the pitch of the lenticular elements forming the lenticular screen is equal to, or slightly less than, the pitch of the groups of pixels.

Alternatively, the second layer comprises a barrier, or colour filters.

When the second layer comprises a lenticular screen, the lenticular elements may be slanted at an angle relative to the columns of pixels. Such an orientation of the lenticular screen relative to the rows and columns forming the display panel improves the perceived resolution of the display device.

The first layer of the device may be curved. This allows a view point correction to be effected which takes into account the fact that a viewer or player will be positioned relatively close to an edge of the display panel when the display panel is positioned in a horizontal orientation.

The display panel may have a substantially horizontal orientation during use. This means that, particularly when the display device is used as a multi-player 3-D game board, the display panel may be mounted on a table, and players may sit around the display panel. When the display device is adapted to serve as a dual player 3-D game board, the two players may sit at opposing sides of the table on which the display panel has been mounted.

Traditionally, display panels of the type hereindescribed have been mounted in a generally vertical orientation. When such a display device is mounted vertically, a viewer viewing an image generated by the display panel and having a static viewing position will view all parts of the display panel at substantially the same viewing angle.

When a display panel is positioned substantially horizontally, the viewing angle at which a viewer views an image generated by the display panel will vary across the display panel.

Typically, the viewing distance of the display will be relatively short. This means that the angle at which the display is viewed varies considerably with the position of an image on the screen. Images formed close to an edge of the display panels will be viewed at a viewing angle that is close to the perpendicular, whereas an image originating from a position close to an opposite edge of the display panel to where a viewer is positioned will be viewed from a more acute viewing angle.

This means that a view point correction must be made in respect of both the perspectives of the shared image component and private image component (when present) generated by the first layer, and in respect of the plurality of views generated by the second layer.

The display device may further comprise a graphics processing engine for carrying out appropriate 3-D rendering, for controlling activation of the display panel thereby to display the appropriate images.

In order that the scene appears realistic from each viewing zone, appropriate perspectives of the scene must be displayed at each viewing zone. In other words, the perspective of the scene visible at each viewing zone must be appropriate for each viewing zone.

The 3-D graphics processing engine may comprise a 3-D rendering unit which calculates the appropriate perspective for each viewing zone.

The 3-D graphics processing engine may further comprise a display panel controller for controlling the display panel according to the rendering required, to generate an appropriate display.

When the display panel comprises a plurality of separately addressable pixels, the display controller serves to control electrical signals driving individual pixels in order to appropriately vary the light transmission characteristics of each pixel.

The 3-D rendering unit is adapted to generate correct perspectives of views for each player, and preferably these perspectives are adjustable as appropriate, depending on the height of a player. Such adjustments may be selected by means of individual controls.

The 3-D rendering unit may be further adapted to interleave each perspective to ensure each perspective is displayed at an appropriate viewing zone.

The 3-D rendering unit may comprise a plurality of first rendering components, each being adapted to render the shared image component to generate one of the plurality of perspectives of the shared image component.

The 3-D rendering unit may comprise a secondary rendering component adapted to render the private image component.

There is further provided a method for generating a scene comprising a shared image component and a private image component, the method comprising the steps of:

generating a plurality of perspectives of the shared image component of the scene;

generating a plurality of views of each perspective of the shared image component to create a plurality of multi-view perspectives of the shared image component;

displaying each multi-view perspective of the shared component such that it is visible at one of a plurality of viewing zones;

generating a private image component of the scene;

displaying the private image component of the scene such that it is visible at one, but not all of the plurality of viewing zones.

The step of displaying the private image component of the scene may comprise the step of displaying the private image component such that it is visible at a single viewing zone or viewing angle only.

The method may comprise the further step of rendering the scene to generate appropriate perspectives and views of each perspective.

The device and method will now be further described by way of example only with reference to the accompanying drawings in which:

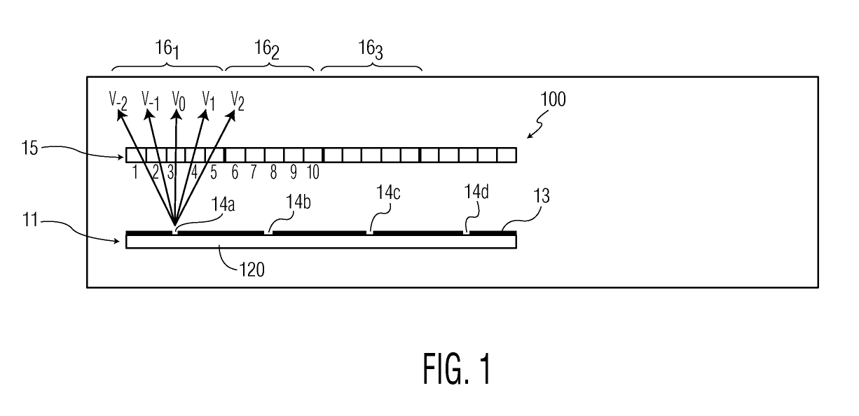

FIG. 1 shows a schematic cross-sectional view of an LC device that uses the parallax barrier approach to display three dimensional images;

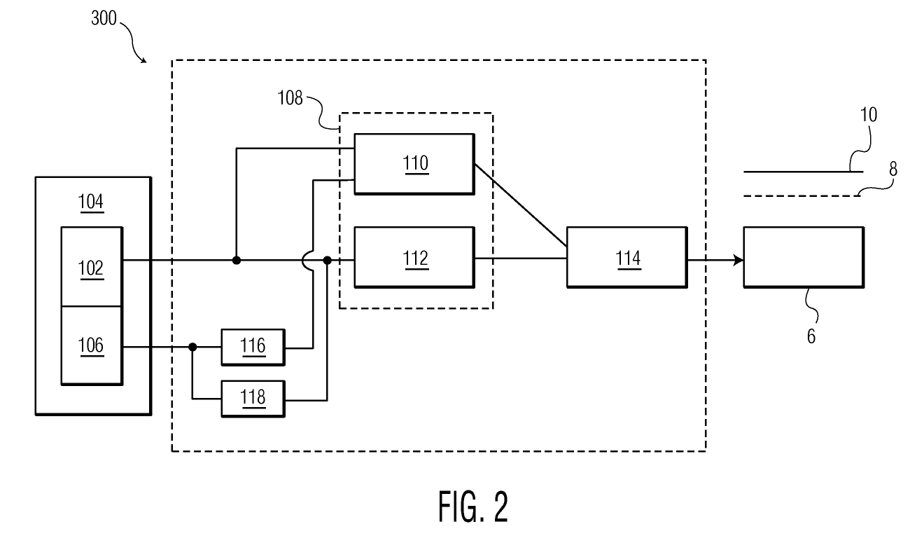

FIG. 2 is a schematic representation of another display device;

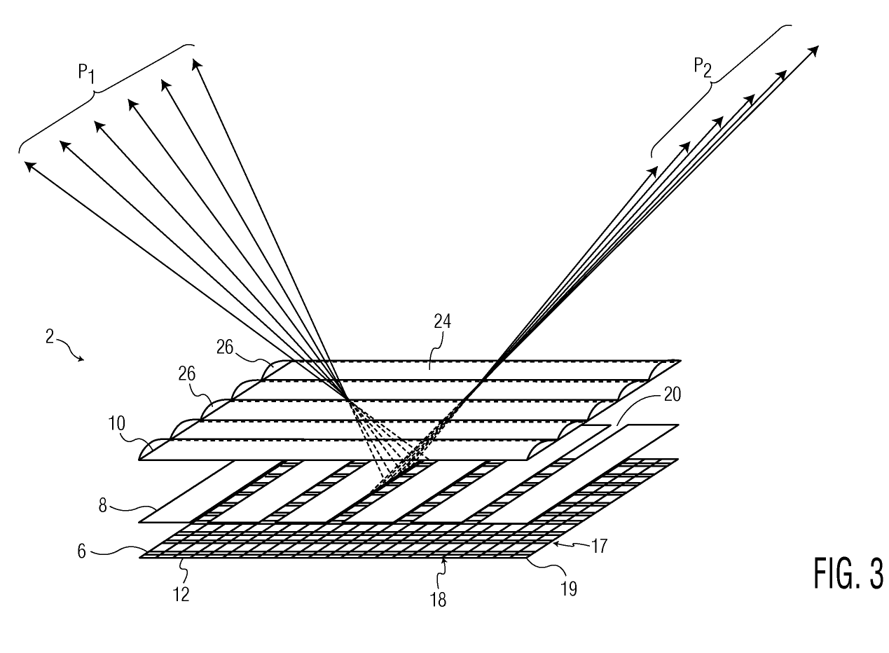

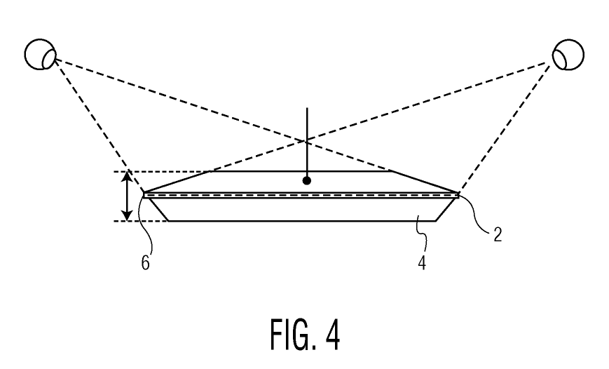

FIG. 3 is a more detailed schematic representation of the display device of FIG. 4 comprising a 3-D game board;

FIG. 4 is a schematic side view of the game board of FIG. 3 showing the 3-D viewing range visible for each of two players;

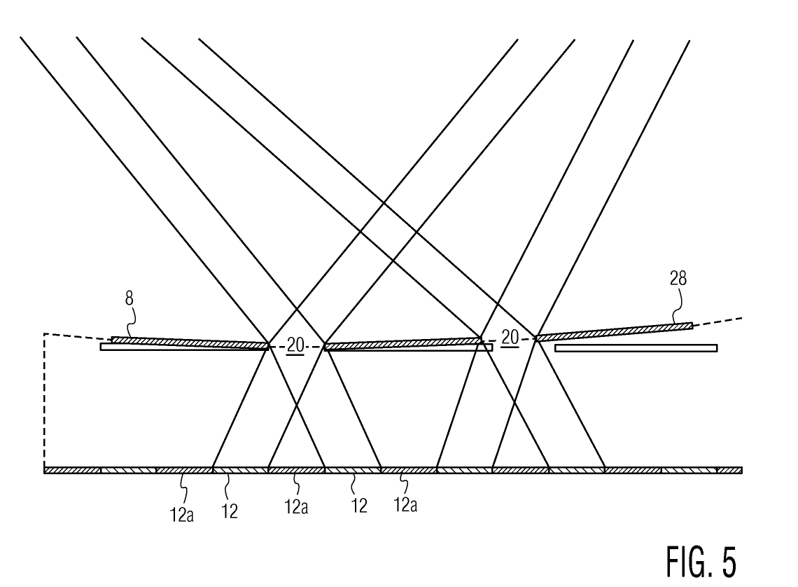

FIG. 5 is a schematic representation of a portion of the 3-D game board of FIG. 3 showing an alternative configuration of the first layer;

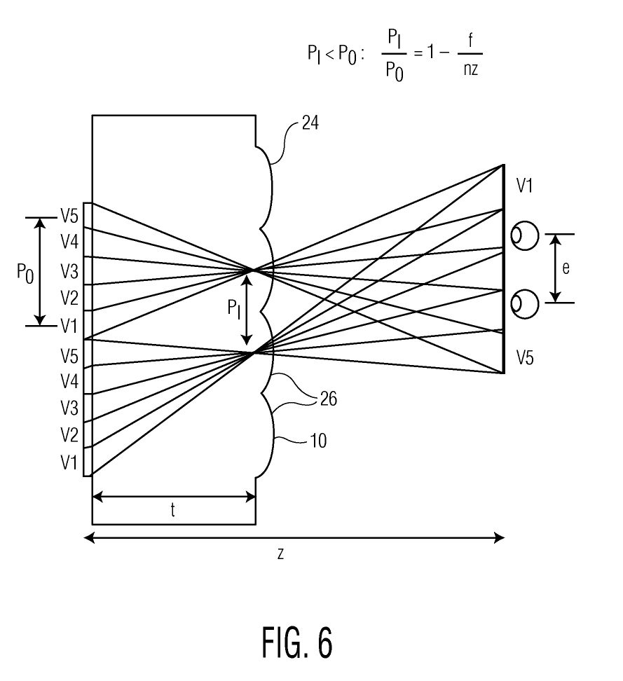

FIG. 6 is a schematic representation showing a view point corrected second layer;

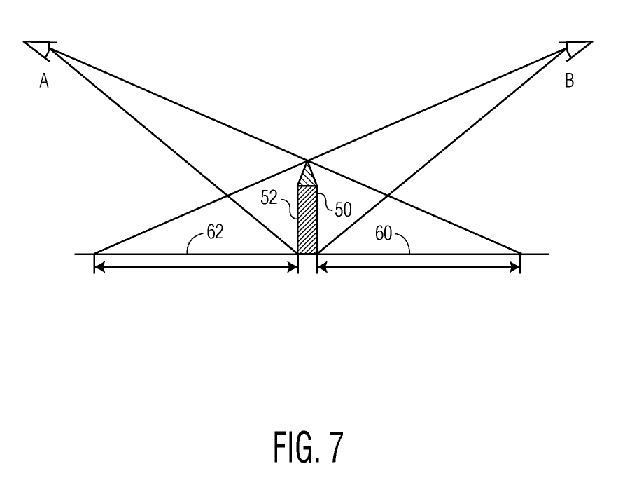

FIGS. 7 to 14 are schematic representations of an image produced by the 3-D game board of FIG. 3 showing different views of the image produced by both the first and second layers of the device.

With reference to FIG. 1, a display device 100 of the parallax barrier type comprises a back panel 11 that provides a plurality of discrete light sources. As shown, the back panel 11 may be formed by way of an areal light source 120 (such as a photoluminescent panel) covered with an opaque mask or barrier layer 13 having a plurality of slits 14a to 14d distributed across its surface. Each of the slits 14 then acts as a line source of light.

A liquid crystal display panel (LCD) 15 comprises a plurality of pixels (eg. numbered 1 to 10 in FIG. 1) which are separately addressable by electrical signals according to known techniques in order to vary their respective light transmission characteristics. The back panel 11 is closely positioned with respect to the LCD panel 15 such that each of the line sources 14 of light corresponds to a group 16 of pixels. For example, pixels 1 to 5 shown as group 16₁ correspond to slit 14a, pixels 6 to 10 shown as group 16₂ correspond to slit 14b, etc.

Each pixel of a group 16 of pixels corresponds to one view V of a plurality of possible views (V₋₂, V₋₁, V₀, V₁, V₂) of an image such that the respective line source 14a can be viewed through one of the pixels 1 to 5 corresponding to that view. The number of pixels in each group 16 determines the number of views of an image present, which is five in the arrangement shown. The larger the number of views, the more realistic the 3-D effect becomes.

Such a device is a multi-view autostereoscopic device, because the autostereoscopic effect is created by the plurality of views created by the groups of pixels of an image.

In order to create a realistic three dimensional effect, it is desirable to ensure small angles exist between the different views in a group of views.

Multi-view display devices which are used to display a three dimensional stereoscopic image or images, therefore display a plurality of views each of which views has a relatively narrow field view. In addition, a graceful fade-over between adjacent views is desirable. Therefore, some cross-talk between adjacent views is acceptable.

In other display devices different perspectives of an image can be seen according to the viewpoint of a user relative to a single display panel. However, it is to be understood that these classes of display devices are not limited to three dimensional display devices, and also include devices that display a plurality of perspectives, but do not display stereoscopic images.

In such devices it is desirable to ensure that there is little, if any cross-talk between the different perspectives in order to ensure that a viewer sees only the perspective appropriate for the viewpoint of the viewer. As a result, the different perspectives will generally be well separated from one another.

Another application for multi-view display devices is to display a plurality of views in which each view may be unrelated to each other view. Each view may be visible to a different user. Such devices have particular application in the automotive field where it may be desirable, for example, for the driver and a passenger to look at different information presented on the same screen. For example, the driver may view a route-planner, while the passenger views his e-mails, or views a DVD. In this document, such views containing significantly different image content will be referred to as “perspectives”.

Another important application for such devices is in the entertainment field where it may be desirable for two players of a 3-D game to see different information presented on the same screen in order that certain information is visible to a particular player only.

As mentioned hereinabove, in order to achieve a graceful fade-over between adjacent views forming a multi-view image of the type described with reference to FIG. 1, some cross-talk between adjacent views is acceptable. In contrast, perspective views should be well separated in order to ensure little if any cross-talk between different perspectives.

Referring now to FIGS. 2, 3, and 4, another display device is designated generally by the reference numeral 2.

In this embodiment the display device 2 comprises a 3-D game board 4 that is adapted to have a substantially horizontal orientation in use. Typically therefore the display device 2 will be mounted on a table in order to provide the horizontally oriented game board 4.

In this embodiment, the game board 4 is adapted for use by two players and therefore comprises a dual view display device. However, other embodiments may comprise a game board adapted for use by more than two players.

A first player, Player A, will be positioned to the left hand side of the game board 4 when viewing the game board from the perspective shown in FIG. 4, and a second player, Player B will be positioned to the right of the game board 4 also when viewing the game board from the perspective shown in FIG. 3.

In the schematic representation shown, and as will be described in more detail hereinbelow in FIG. 3 the first player will be able to see a multi-view perspective (P₁) of an image produced by the device 2 which is directed towards the left hand side of the device 2, and the second player will be able to see a multi-view perspective (P₂) of an image produced by the device 2 formed to the right hand side of the device 2.

The device 2 comprises a display panel 6, a first layer 8 in optical association with the display panel 6 and a second layer 10 also in optical association with the display panel.

In the FIG. 3 device, the first layer 8 is positioned between the display panel 6 and the second layer 10.

The display panel is a LC display and comprises a plurality of separately addressable pixels 12 arranged in columns 17 and rows 18. Each pixel comprises three sub-pixels 19 comprising a red, a green and a blue sub-pixel respectively.

The first layer 8, in this embodiment, comprises a barrier having a plurality of slits 20 each of which slits extends substantially in the direction of the rows 18 of the array of pixels 12.

The second layer 10 comprises a lenticular screen 24 comprising a plurality of elongate lenticular elements 26, which in this example extend substantially in the direction of the columns 17 of the pixels 12. In other embodiments, the lenticular elements 26 may be slanted relative to the columns 17 of the pixels 12.

The first layer 8 is positioned relative to the pixels 12 in order to that the two multi-view perspectives, P₁, P₂ of an image produced by the display device 2 are visible in predetermined viewing zones only. In this embodiment, player A is positioned at a first viewing zone, and player B is positioned at a second viewing zone.

As will be described in more detail hereinbelow the image processing engine 300 (shown schematically in FIG. 2) interweaves the pixels so that, in this embodiment, a first set of alternating rows of pixels is responsible for generating the perspective visible to player A, and a second set of alternating rows of pixels is responsible for generating the perspective visible to player B. The relative position of the slits in the barrier, and the pixels means that one player can see light emitted from the appropriate set of alternating rows of sub-pixels only, the light emitted by the other set of alternating rows of sub-pixels being masked by the barrier, and therefore not visible to that player.

Additionally, as shown in FIG. 5, the first layer 8 may have a curved surface 28 as shown in FIG. 5 to produce a view point corrected barrier forming the first layer 8.

Cross talk is eliminated, or significantly reduced by separating the alternating sets of rows of pixels 12 with dark pixels 12a as shown in FIG. 5.

Turning now to FIG. 6, the view point correction that must be applied to the second layer 10 is shown schematically. FIG. 6 shows a plurality of the pixels 12 forming the display panel 6 which have been numbered 1 to 10. Each of the pixels is separately addressable as has been described hereinabove. The pixels illustrated in FIG. 6 form two groups each of which comprises one pixel corresponding to a particular view. In the illustrated embodiment there are five possible views from each group of pixels (V₁, V₂, V₃, V₄ and V₅). The number of pixels in each group (here five) determines the number of views of an image present. The larger the number of views, the more realistic the 3-D effect becomes and the more oblique viewing angles are provided.

In order to make a view point correction in respect of the second layer 10, the pitch of the elongate lenticular elements should be less than the pitch of a group of pixels formed in the rows of pixels as shown in FIG. 6.

In particular, the pitch of the lenticular elements p₁ and the pitch of the groups of pixels p₀ are defined by the following equation:

$$\frac{{p}_{1}}{{p}_{0}} = 1 - \frac{f}{nz}$$

where f is the thickness of the lenticular sheet, and z is the distance (height) between a player and the display panel 6, n is the refractive index of the optical medium between the LC cells and the lenticular screen.

The image processing engine will now be described in more detail with particular reference to FIG. 2.

As has been described hereinabove, the display device 2 is adapted to generate multi-view perspectives of a shared image component 102 forming part of a scene 104. The scene further comprises a private image component 106.

The image processing engine 300 comprises a 3-D rendering unit 108 comprising a first 3-D rendering component 110 and a second 3-D rendering component 112, a display panel controller 114. The 3-D rendering unit further comprises a first, secondary 3-D rendering component 116 and a second, secondary 3-D rendering component 118.

In use of the device, a scene will be developed in a known manner which scene is defined by a set of data defining objects in the scene, textures, shapes etc. The scene 104 comprises a shared image component 102 and a private image component 106.

Data defining the shared image component is rendered separately by 3-D rendering components 110 and 112 respectively. The rendering component 110 produces the appropriate data to generate the perspective of the shared image component 102 viewed by player A, and the rendering component 112 renders the data to generate the perspective visible to player B. The rendered data then passes to the display controller 114 which serves to filter and interweave the output of the 3-D rendering components as appropriate and to drive individual pixels in display panel 6 so that the correct perspective is visible to the appropriate player.

The private image component 106 is divided into two private image components 116 to be viewed by player A, and 118 to be viewed by player B. This data is rendered in a similar manner to that described hereinabove with reference to the shared component by secondary rendering components 116, 118. In many cases, this private data contains score data in text and numbers which are rendered into flat image planes, which are properly positioned in 3-D space by the 3-D rendering components 110 and 112 respectively. The rendered data is fed to the panel controller 114 which drives appropriate individual pixels in the display panel 6 to ensure that the appropriate private image data, rendered by component 116, 118 is visible only to the appropriate player A or B.

The components forming part of the image processing engine 300 may be shared or used in time multiplex manner. For example, the 3-D rendering unit may comprise a single unit rather than separate components 110, 112, 116 and 118.

In addition, components forming the image processing engine 300 may be grouped differently than as shown in FIG. 2.

Turning now to FIGS. 7 to 14 images visible to each player (shown in these figures as player A and player B) are schematically shown.

Consider first a scene consisting of a single tower 50. The tower has a front side 52 that has a door 54, and a back side 56 that has two windows 58. Two opposing viewers (players A and B) are able to view the scene.

Player A will see the front side 52 of the tower including the door 54 whereas viewer B will see the back side 56 of the tower including the windows 58.

As can be seen from FIG. 7, the display panel 6 of the horizontally positioned game board 4 needs to take into account the horizontal image projection of the tower 50. The horizontal image projection is represented by line 60 for the view seen by player A, and by line 62 for the view seen by player B. In this example the tower is stretched by approximately 230% in height as a result of the horizontal projection.

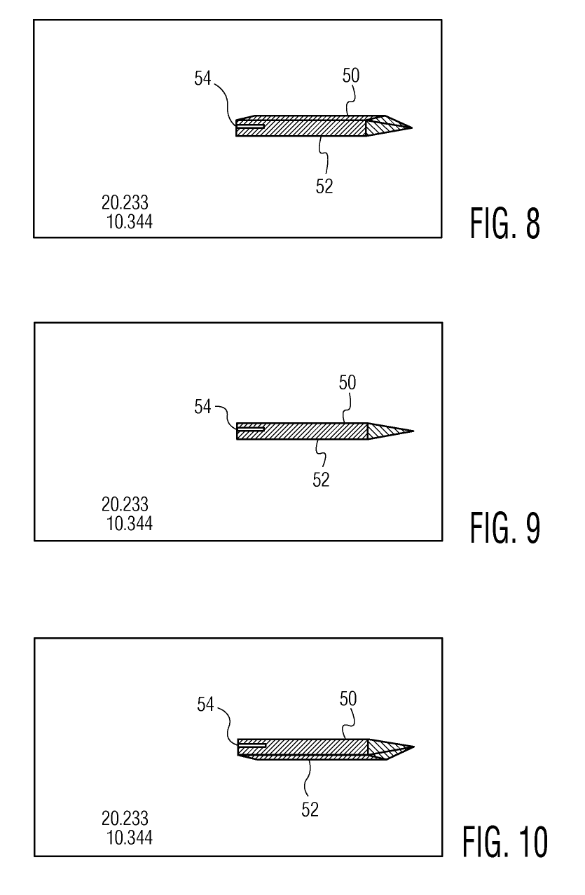

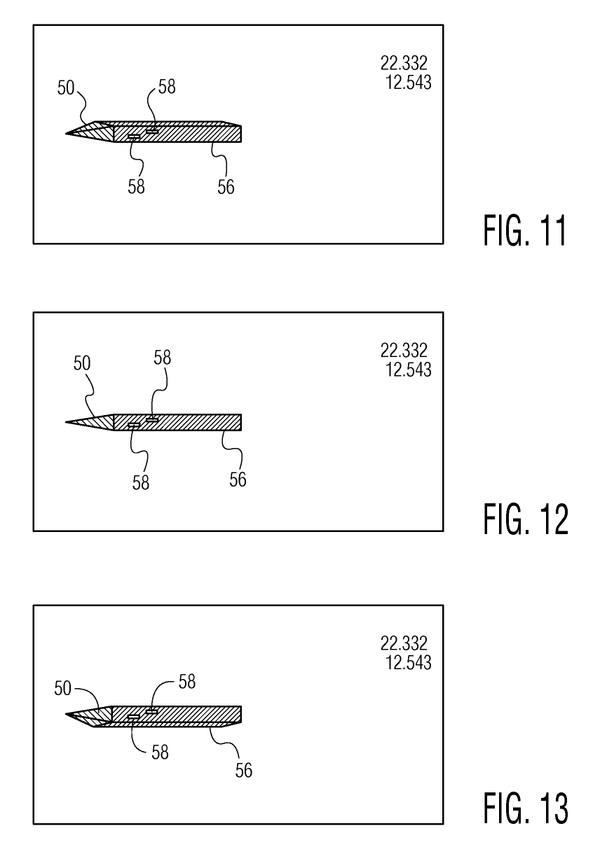

Turning now to FIGS. 8 to 13, the views visible by each player are shown. FIGS. 8 to 10 show the views that may be seen by Player A, and FIGS. 11 to 13 show the views that are visible to Player B.

FIG. 8 shows a left view of the tower visible by Player A, FIG. 9 shows a central view of the tower visible by Player A, and FIG. 10 shows a right view of the tower visible by player A.

Each of these views (in FIGS. 8 to 10) also contains information relating to the score of Player A and the amount of money owned by that player. This information is not visible to Player B.

Similarly, FIGS. 11, 12 and 13 shown respectively the left view, centre view and right view visible to Player B. These views similarly contain private information relating to the score and the money owned by Player B, and not visible to Player A.

In many cases an image and depth representation is used to derive the multi-view stereoscope images. In such cases, not only must the image be projected properly, but the depth must also be properly projected.

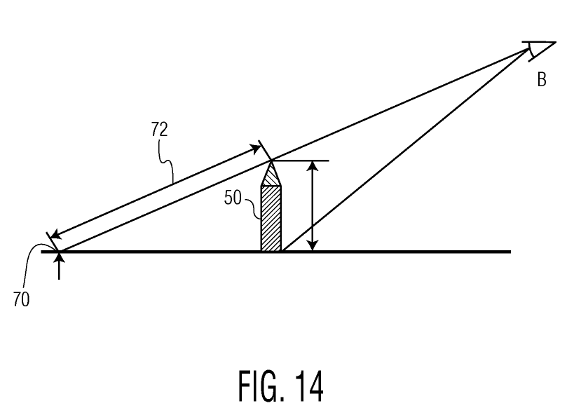

FIG. 14 shows the depth transformation for Player B. The height of the tower 50 measured perpendicular to the display panel 6 is indicated by the depth position 70 and is mapped on a projected depth by:

1. First moving the depth position according to the image projection transformation (i.e., the depth information for the top of the tower is related to the projected screen position of the tower top indicated at 70 and labelled as the depth position).

2. The depth value is scaled according to the depth projection following the line of sight of the viewer. In this case the depth value is scaled by approximately 230% as indicated by line 72 (a depth projection B).

A particularly advantageous processing order is as follows:

1. Perform image projection;

2. Perform depth transformation projection; and

3. Perform rendering using projected image and transformed depth.

The projection calculations illustrated in FIGS. 7 to 14 are typically carried out by the 3-D rendering components 110, 112 in FIG. 2.

1. A display device (2) for displaying a scene (104) comprising a shared image component (102) and a private image component (106), wherein the display device is adapted to display a plurality of perspectives of the shared image component and a plurality of views of each of the plurality of perspectives such that a multi-view perspective (P₁; P₂) of the shared image component is visible at each of a plurality of viewing zones, the display device being further adapted to display the private image component such that it is visible at one or more, but not all of the viewing zones.

2. A display device (2) according to claim 1, comprising:
a display panel (6) for displaying the scene;
a first layer (8) in optical association with the display panel adapted to generate: a plurality of perspectives of the shared image component; and the private image;
a second layer (10) in optical association with the display panel adapted to generate a plurality of views of each perspective of the shared image component.

3. A display device (2) according to claim 2 wherein the display comprises a plurality of private image components, each visible at least one, but not all of the viewing zones.

4. A display device (2) according to claim 3 wherein each private image component is visible at a single viewing zone only.

5. A display device (2) according to claim 2 wherein the second layer (10) is adapted to display a plurality of views of the respective perspectives with optionally private image components.

6. A display device (2) according to claim 2 or any claim dependent thereon wherein the display panel (6) comprises a plurality of separately addressable pixels (12) arranged in rows (18) and columns (17).

7. A display device (2) according to claim 6 wherein the first layer (8) comprises a barrier layer comprising a plurality of slits (20), each of which slits extends in a direction substantially parallel to the rows (18) of the pixels.

8. A display device (2) according to claim 2 wherein the second layer (10) comprises a lenticular screen (24) comprising a plurality of elongate lenticular elements (26).

9. A display device (2) according to claim 8 wherein each row of pixels (12) comprises a plurality of groups of pixels, each pixel in a group providing a different view of a perspective of the image content, the pitch (p₁) of the lenticular elements forming the second layer being less than the pitch (p₀) of the group of pixels.

10. A display device (2) according to claim 8 wherein the lenticular elements (26) are slanted at an angle relative to the columns (17) of pixels.

11. A display device (2) according to claim 1 wherein the display panel (6) has an in use substantially horizontal orientation.

12. A display device (2) according to claim 2 dependent thereon further comprising an image processing engine (300).

13. A display device (2) according to claim 12 wherein the image processing engine comprises a 3-D rendering unit (108).

14. A display device (2) according to claim 13 wherein the 3-D rendering unit (108) comprises a plurality of first rendering components (110), each first rendering component being adapted to render the shared image component (102) to generate one of the plurality of perspectives of the shared image component.

15. A display device (2) according to claim 12 wherein the 3-D rendering unit (108) comprises a secondary rendering component (116) adapted to render the private image component (106).

16. A display device (2) according to claim 12 wherein the image processing engine (300) comprises a display panel controller (114) for controlling the output of the display panel.

17. A display device (2) comprising:
a display panel (6) for displaying a scene perspectives of which are visible at a plurality of viewing zones;
a first layer (8) in optical association with the display panel adapted to generate a plurality of perspectives of the scene;
a second layer (10) in optical association with the display panel adapted to generate a plurality of views of a respective perspective such that a multi-view perspective of the scene is visible at each viewing zone.

18. A display device (2) according to claim 17 wherein the image comprises a shared image component (102), a perspective to which is visible at each viewing zone, and a private image component (106) visible at least one, but not all viewing zones, the first layer being adapted to generate:
a plurality of perspectives of a shared image content; and
the private image component.

19. A 3-D game board (4) comprising a display device (2) according to claim 1.

20. A method for generating a scene (104) comprising a shared image component (102) and a private image component (106), the method comprising the steps of:
generating a plurality of perspectives of the shared image component of the scene;
generating a plurality of views of each perspective of the shared image component to create a plurality of multi-view perspectives of the shared image component;
displaying each multi-view perspective of the shared component at one of a plurality of viewing zones;
generating a private image component of the scene;
displaying the private image component of the scene at one, but not all of the plurality of viewing zones.

21. A method according to claim 20 wherein the step of displaying the private image component of the scene comprises the step of displaying the private image component such that it is visible at a single viewing zone or viewing angle only.

22. A method according to claim 20 comprising the further step of rendering the scene to generate appropriate perspectives of the shared image component of the scene, views of each perspective of the shared image component of the scene.
